(19) United States
(12) Patent Application Publication
(10) Pub. No.: US 2019/0009619 A1
(43) Pub. Date: Jan. 10, 2019

(54) A TIRE WITH RADIAL OR BIAS CARCASS

(71) Applicant: COMPAGNIE GENERALE DES ETABLISSEMENTS MICHELIN, Clermont-Ferrand (FR)

(72) Inventors: Kazutaka YOKOKAWA, Shinjuku-ju, Tokyo (JP); Tomohiro SEII, Shinjuki-ku, Tokyo (JP); Masayoshi NOMURA, Shinjuki-ku, Tokyo (JP)

(73) Assignee: COMPAGNIE GENERALE DES ETABLISSEMENTS MICHELIN, Clermont-Ferrand (FR)

(21) Appl. No.: 16/065,967

(22) PCT Filed: Dec. 25, 2015
(86) PCT No.: PCT/JP2015/086593

§ 371 Date: Jun. 25, 2018

(51) Int. Cl. B60C 13/02

(52) U.S. Cl. CPC B60C 13/02; B60C 11/01

(57) ABSTRACT

The tire has a carcass reinforcement. A crown reinforcement is disposed on the carcass reinforcement and is made up reinforcing elements. A tread is placed on the crown reinforcement and has two axial ends. At least one of the axial ends has a circumferential groove. The tread is connected by sidewalls to bead zones, each comprising a reinforcing element. At least one sidewall protuberances alternating with voids. Each protuberance has a height hp, a length lp and a width wp and a base part which has a height hb and is formed on the exterior surface of the sidewall and a top part which extends outwardly from the base part and has a top surface. The top surface has an inclined face and a remaining face connected to the inclined face by a connecting part. A height hp of the protuberance is maximal at the connecting part.

### CROSS-REFERENCE TO RELATED APPLICATIONS

The present application claims priority to PCT International Patent Application Serial No. PCT/JP2015/086593, filed Dec. 25, 2015, entitled “A TIRE WITH RADIAL OR BIAS CARCASS”.

### BACKGROUND OF THE INVENTION

### 1. Field of Invention

The present invention relates to a tire, in particular to a tire with radial or biased carcass.

### 2. Related Art

Radial tires are gradually imposed on various markets, notably the market for passenger car tires. This success is due in particular to the endurance, comfort and low rolling resistance qualities of radial technology.

The principal parts of a tire are a tread, sidewalls and beads. The beads are intended to come into contact with the rim. In a tire with radial technology, each principal component constituting the tire, namely the tread, the sidewalls and the beads, has well separated functions each other, and therefore has a well-known specific constitution.

A radial tire is essentially reinforced by a carcass reinforcement comprising at least one carcass ply set at an angle substantially equal to 90° with respect to the circumferential direction of the tire. This carcass reinforcement is surmounted radially on the outside, and under the tread, by reinforcing plies that form a belt.

A cross-ply tire (or a biased tire) differs from a tire with the radial technology in that there are at least two crossed carcass plies set at an angle other than 90° with respect to the circumferential direction of the tire. The carcass plies are said to be as “crossed” because the angles are opposite signs from one carcass ply to the other.

Following the emergence of a tire with radial carcass, certain cross-ply tires were also provided with the reinforcing belt under the tread.

In both these types of tire, the tread, intended to come into direct contact with the ground, notably has the function of providing contact with the roadway and needs to adapt to the shape of the ground. The sidewalls themselves absorb the unevennesses of the ground by transmitting the mechanical forces required to support the load of the vehicle and ensure movement of the vehicle.

The belt reinforcement is a reinforcement which, on the one hand, needs to be sufficiently rigid with regard to edge deformations so that the tire can develop the cornering forces necessary for steering, and transmit torque for driving or for braking and, on the other hand, be very soft in bending, which means to say allow variations in curvature in its plane in order to provide a sufficient area of contact of the tire with the ground.

As a result, the belt reinforcement generally has a composite structure allowing it to offer the required rigidity with a relatively low weight. The belt reinforcement is generally made up of at least two plies set at different angles, comprising reinforcement elements in the form of cables, coated with rubber. The cables in the reinforcement elements are crossed from one ply to the other with respect to the circumferential direction and may or may not be symmetric with respect to this direction.

JP2008068716A discloses, in FIG. 1, a tire comprising sidewalls with external reinforcements which are intended to lower the internal temperature in the tire portion easily deteriorated during usage. However arrangement of these reinforcements on the sidewalls does not allow the sidewalls of the tire to be reinforced so as to withstand lateral knocks, such as kerbing (knocks against a kerb) or in potholes.

Indeed such knocks, which occur at various speeds and/or at various angles of attack, with conventional tire designs may cause damage, sometimes even going so far as to cause the tire to be scrapped.

Furthermore, the current trend to use aluminum rims rather than steel to contribute in particular to the total esthetic of vehicle has the consequence of causing the rupture of the components of the carcass starting from the speed definitely lower when the tire suffers lateral knocks.

Moreover, the current desire to use tires with increasingly short sidewall height has, as yet another consequence, the fact that a knock to such sidewalls causes more intense degradation than the sidewall with taller sidewall height, thus more damaging to the tire.

WO2014/207093A1 discloses, in FIG. 2, a tire having a plurality of protuberances on the sidewall for improving robustness of the sidewall and carcass reinforcement against lateral knocks. However as such protuberances are manufactured integrally simultaneously with the other part of the tire from the green tire in the molding element, air evacuation from a space between the molding element and the green tire is required. Therefore, a plurality of holes (venting holes) is provided in the molding element. Such holes generate a plurality of spews on a surface of the protuberance which makes aesthetic of not only the protuberance but also the sidewall of the tire having such protuberances unfavorable. Further, trimming of such spews after curing is required which degrades manufacturing efficiency of such tire.

The air evacuation from the molding element may be achieved, for example, by putting a small guide groove in the molding element, which creates a small projected line or an obstacle on the protuberance. This small projected line clearly impact unfavorably aesthetic of the protuberance and the tire. The air evacuation from the molding element may also be achieved for example by making an outermost face of the protuberance with an smooth inclined and/or curved surface which a height of such protuberance would be maximal in such outermost face, but air evacuation efficiency is still not sufficient.

### Definitions

A “radial direction/orientation” is a direction/orientation perpendicular to axis of rotation of the tire. This direction/orientation corresponds to thickness direction of the tread.

An “axial direction/orientation” is a direction/orientation parallel to axis of rotation of the tire.

A “circumferential direction/orientation” is a direction/orientation which is tangential to any circle centered on axis of rotation. This direction/orientation is perpendicular to both the axial direction/orientation and the radial direction/orientation.

A “tire” means all types of elastic tire whether or not subjected to an internal pressure.

A “green tire” means a superposition of a plurality of semi-finished rubber products present in the form of strips or sheets, with or without reinforcement. The green tire is intended to be vulcanized in a mold in order to obtain the tire.

A “mold” means a collection of separate molding elements which, when brought closer towards one another, delimit a toroidal molding space.

A “molding element” of a mold means part of a mold. A molding element is, for example, a mold segment.

A “molding surface” of a molding element means a surface of the mold that is intended to mold a surface of the tire.

A “tread” of a tire means a quantity of rubber material bounded by lateral surfaces and by two main surfaces one of which is intended to come into contact with ground when the tire is rolling.

A “groove” is a space between two rubber faces/sidewalls which do not contact between themselves under usual rolling condition connected by another rubber face/bottom. A groove has a width and a depth.

A term “does not interrupt” means that the radially upper end of a protuberance is either adjacent to the circumferential groove or distant by a distance “d” substantially arranged in a radial direction and of between 2 and 10 mm.

A term “partially interrupts” means that the radially upper end of a protuberance partially intersects the circumferential groove.

A term “completely interrupts” means that the radially upper end of a protuberance meets the axially outer end of the tread that is closest to it.

A “height of protuberance” means that the maximum height of the protuberance measured perpendicular from exterior surface of the sidewall.

A “height of base part” means that the maximum height of the base part measured perpendicular from exterior surface of the sidewall.

A “width of protuberance” means that the maximum width of the protuberance measured in the circumferential direction.

A “length of protuberance” means that the maximum length of the protuberance measured in the radial direction.

### SUMMARY OF THE INVENTION

It is thus an object of the disclosure to provide a tire having a plurality of protuberances, such tire can provide favorable aesthetic of the protuberances while maintaining satisfactory robustness of the sidewalls and the carcass reinforcement.

The present disclosure provides a tire for a rolling assembly comprising a rim and a tire, the tire comprising at least one carcass reinforcement, a crown reinforcement being disposed radially outward of the carcass reinforcement and being made up of at least one layer of reinforcing elements, a tread being placed radially outward of the crown reinforcement and having two axially outermost ends, at least one of the axially outermost end of the tread comprising a circumferential groove, the tread being connected by two sidewalls to two bead zones each comprising at least one circumferential reinforcing element, at least one sidewall comprising, on its exterior surface, a series of protuberances alternating with voids, each protuberance having a height hp, a length lp and a width wp being positioned at the surface of the sidewall, each the protuberance comprising a base part having a height hb and formed on the exterior surface of the sidewall and a top part extending outwardly from the base part and having a top surface spaced outwardly from the exterior surface of the sidewall, the tire being characterized in that the top surface comprises at least one inclined face axially inwardly inclined and a remaining face connected to the inclined face by a connecting part, and in that a height hp of the protuberance from the exterior surface of the sidewall is maximal at the connecting part.

This arrangement improves air evacuation efficiency from a space between the molding element and the green tire with less number of venting holes, which leads favorable aesthetic of the protuberance and the tire, while maintaining satisfactory robustness of the sidewalls and the carcass reinforcement.

Since at least one sidewall is provided, on its exterior surface, with a series of protuberances alternating with voids, the tire is able to withstand particularly violent lateral knocks without causing substantial damage that could possibly carry appreciable risk to the vehicle passengers.

Since protuberance comprises a base part having a height hb and formed on the exterior surface of the sidewall and a top part extending outwardly from the base part, capability of such protuberance to withstand particularly violent lateral knocks is maintained.

Since the top surface of the top part comprises at least one inclined face axially inwardly inclined and a remaining face connected to the inclined face by a connecting part and a height hp of the protuberance from the exterior surface of the sidewall is maximal at the connecting part, air to be evacuated from a space between the molding element and the green tire would surely and smoothly be flown to the connecting part where the green tire touches to the molding element at the very last moment during vulcanization, thus it is possible to efficiently evacuates air between the molding element and the green tire with less number of venting holes which leads favorable aesthetic of the protuberance and the tire.

The tire, and a mounted rolling assembly comprising a rim and the tire according to the disclosure also has an advantage of offering overall performance, such as rolling resistance, wear, endurance, that is similar to that of tires without protuberances on the sidewall.

In another preferred embodiment, the top part comprises at least three faces.

According to this arrangement, it is possible to further improve air evacuation efficiency between the molding element and the green tire with less number of venting holes which leads further favorable aesthetic of the protuberance and the tire.

In another preferred embodiment, the top part comprises a face independent from the base part.

According to this arrangement, it is possible to add freedom to design the protuberance having further favorable aesthetic while maintaining good air evacuation efficiency between the molding element and the green tire.

In another preferred embodiment, at least two protuberances have different length lp from one another.

According to this arrangement, it is possible to add freedom to design the protuberance as a series of protuberances having further favorable aesthetic while maintaining good air evacuation efficiency between the molding element and the green tire.

In another preferred embodiment, at least two protuberances have different width wp from one another.

According to this arrangement, it is possible to add freedom to design the protuberance as a series of protuberances having further favorable aesthetic while maintaining good air evacuation efficiency between the molding element and the green tire.

In another preferred embodiment, at least two protuberances have different height hp from one another.

According to this arrangement, it is possible to add freedom to design the protuberance as a series of protuberances having further favorable aesthetic while maintaining good air evacuation efficiency between the molding element and the green tire.

In another preferred embodiment, at least two protuberances have different height hb of the base part from one another.

According to this arrangement, it is possible to add freedom to design the protuberance as a series of protuberances having further favorable aesthetic while maintaining good air evacuation efficiency between the molding element and the green tire.

In another preferred embodiment, a difference between the height hp of each the protuberance and the height hb of the base part of the protuberance is at most equal to 2.0 mm or at most equal to 50% of the height hp of the protuberance whichever is smaller.

According to this arrangement, it is possible to achieve both of the robustness of the sidewall and the carcass reinforcement, and good air evacuation efficiency between the molding element and the green tire at the same time. In other words, if this difference is more than 2.0 mm or more than 50% of the height hp of the protuberance, there is a risk that the protuberance bends too much during lateral knocks and may be destroyed. By setting this difference at most equal to 2.0 mm or at most equal to 50% of the height hp of the protuberance whichever is smaller, robustness of the sidewall and of the carcass reinforcement is maintained while also maintaining good air evacuation efficiency between the molding element and the green tire.

In another preferred embodiment, the height hp of each protuberance is at least equal to 2.0 mm and at most equal to 10.0 mm.

If this height hp is less than 2.0 mm, robustness of the sidewall and of the carcass reinforcement would be degraded due to insufficient volume of the protuberance. If this height hp is more than 10.0 mm, a size of the protuberance becomes important and may penalize one of overall performance such as rolling resistance. By setting this height hp of each protuberance at least equal to 2.0 mm and at most equal to 10.0 mm, the protuberance is able to provide enough robustness of the sidewall and of the carcass reinforcement without degrading overall performance of the tire.

In another preferred embodiment, the width wp of each the protuberance is at least equal to 2.5 mm and at most equal to 12.0 mm.

If this width wp is less than 2.5 mm, robustness of the sidewall and of the carcass reinforcement would be degraded due to insufficient volume of the protuberance as the protuberance may bend easily with lateral knock. If this width wp is more than 12.0 mm, a size of the protuberance becomes important and may penalize one of overall performance such as rolling resistance. By setting this width wp of each protuberance at least equal to 2.5 mm and at most equal to 12.0 mm, the protuberance is able to provide enough robustness of the sidewall and of the carcass reinforcement without degrading overall performance of the tire.

In another preferred embodiment, two adjacent protuberances are spaced apart by a distance less than or equal to twice the width wp of the protuberance.

According to this arrangement, it is possible to prevent a risk that lateral knocks occurs on the sidewall where no protuberance exists (or at the void) with minimum amount of extra rubber due to protuberance, thus satisfactory robustness of the sidewall and of the carcass reinforcement would be maintained without degrading overall performance of the tire.

In another preferred embodiment, two adjacent protuberances are substantially parallel from one another.

According to this arrangement, it is possible to design a series of protuberance in harmony with tread pattern thus increases efficiency to design such the series of protuberance.

### BRIEF DESCRIPTION OF THE DRAWINGS

Other characteristics and advantages of the disclosure arise from the description made hereafter in reference to the annexed drawings which show, as nonrestrictive examples, the embodiments of the disclosure.

In these drawings:

FIG. 1 is a schematic cross sectional view of a mounted rolling assembly comprising a rim and a tire according to a first embodiment of the present disclosure;

FIG. 2 is a schematic perspective view of a portion of a tire according to the first embodiment of the present disclosure;

FIG. 3 is an enlarged schematic view of a portion of sidewall according to the first embodiment of the present disclosure;

FIG. 4 is a cross sectional view taken along line IV-IV in FIG. 3; and

FIG. 5 is an enlarged schematic view of a portion of sidewall of the tire according to a second embodiment of the present disclosure.

### DETAILED DESCRIPTION OF THE INVENTION

Preferred embodiments of the present disclosure will be described below referring to the drawings.

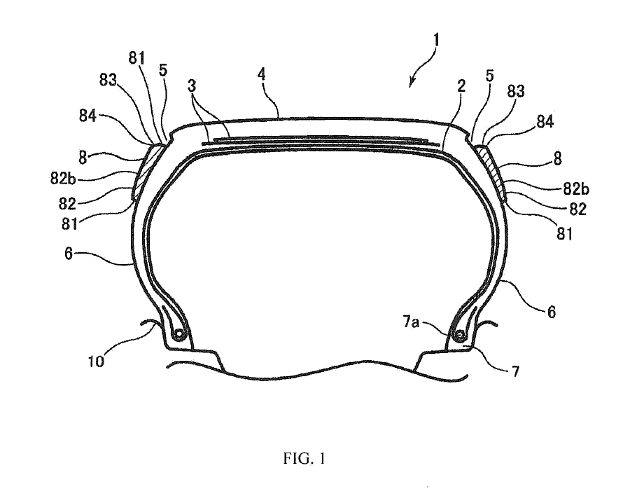

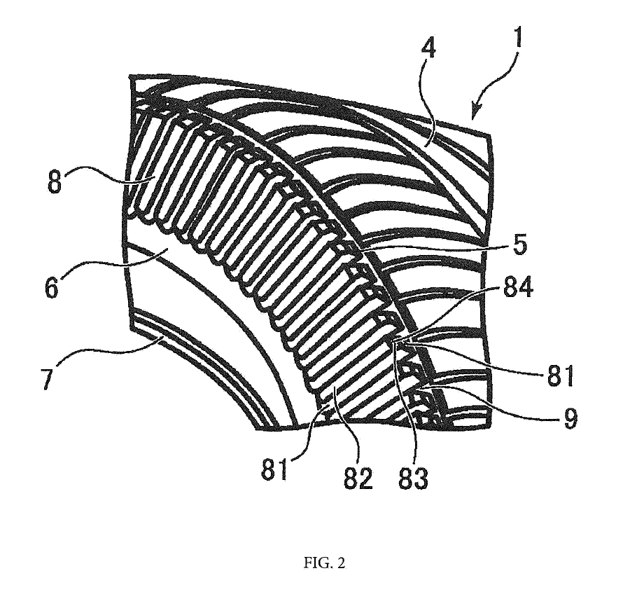

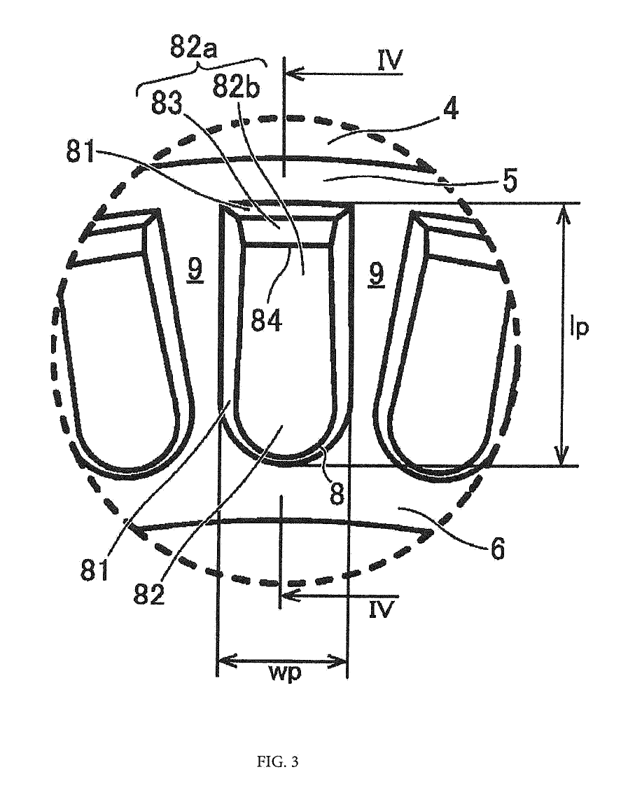

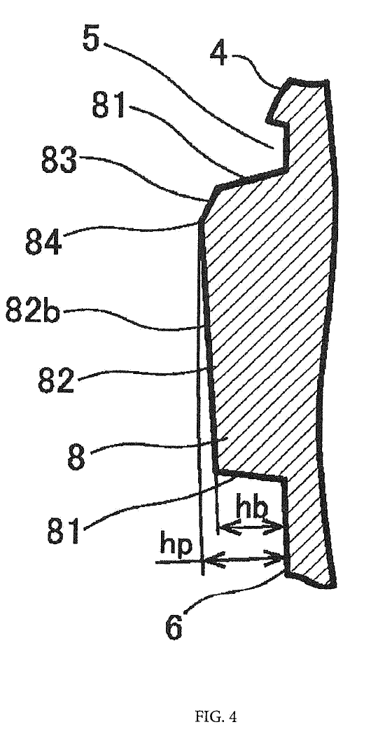

A tire according to a first embodiment of the present disclosure will be described referring to FIGS. 1, 2, 3 and 4. FIG. 1 is a schematic cross sectional view of a mounted rolling assembly comprising a rim 10 and a tire 1 according to the first embodiment of the present disclosure. FIG. 2 is a schematic perspective view of a portion of a tire 1 according to the first embodiment of the present disclosure. FIG. 3 is an enlarged schematic view of a portion of sidewall 6 according to the first embodiment of the present disclosure. FIG. 4 is a cross sectional view taken along line IV-IV in FIG. 3.

The tire 1 having dimension 205/55R16 and comprises a carcass reinforcement 2, a crown reinforcement 3 being disposed radially outward of the carcass reinforcement 2, a tread 4 being placed radially outward of the crown reinforcement, the tread 4 being connected by two sidewalls 6 to two bead zones 7. The bead zones 7 are intended to come into contact with a rim 10 (partially depicted). Each bead zone 7 comprises at least one circumferential reinforcing element 7a. On the exterior surface of the sidewalls 6, a series of protuberances 8 is integrally provided alternating with voids 9 (shown in FIG. 2). Further, a circumferential groove 5 is formed between axially outermost end of the tread 4 and the series of protuberances 8 on the exterior surface of the sidewalls 6. Adjacent protuberances 8 are substantially oriented in parallel.

Each protuberance 8 has a generally flat rectangular parallelepiped shape and is oriented so as to extend in radial direction. Specifically, the protuberance 8 is slightly tapered in an axially outward direction. FIG. 1 shows only protuberances 8 in cross section.

As shown in FIGS. 1 and 2, the protuberance 8 consisting of a base part 81 integrally formed with the exterior surface of the sidewall 6, and a top part 82 extending axially outwardly from the base part 81 and having, on its top, a top surface 82a spaced outwardly from the exterior surface of the sidewall 6. The top surface 82a includes an inclined face 83 on a radially outward portion. The inclined face 83 axially inwardly inclined toward radially outward direction as shown in FIGS. 3 and 4. The remaining portion of the top surface 82a is a flat face (remaining face) 82b axially inwardly inclined toward radially inward direction.

The inclined face 83 is connected to the flat face 82b of the top surface 82a through a ridge-like connecting part 84. A height (a distance between the top surface 82a and the exterior surface of the sidewalls 6 in a direction perpendicular to the exterior surface of the sidewalls 6 as shown in FIG. 4) of the protuberance 8 from the exterior surface of the sidewall 6 is maximal at the connecting part 84 with a height hp.

The series of protuberance 8 is arranged on the exterior surface of the sidewall 6 at angularly regular intervals such that the radially outward end of the protuberance 8 is located at position radially inwardly adjacent to the circumferential groove 5. Each the protuberance 8 has a length lp and a width wp. Two adjacent protuberances 8 are spaced apart by a void at a distance less than or equal to twice the width wp of the protuberance 8, as shown in FIGS. 2 and 3.

The base part 81 has a height hb (a distance between top of the base part 81 and the exterior surface of the sidewalls 6 in a direction perpendicular to the exterior surface of the sidewalls 6 as shown in FIG. 4). The height hb is lower than the height hp (a distance between the connecting part 84 and the exterior surface of the sidewalls 6 in a direction perpendicular to the exterior surface of the sidewalls 6 as shown in FIG. 4) of the protuberance 8 by at most equal to 2.0 mm or at most equal to 50% of the height hp of the protuberance 8 whichever is smaller.

Since at least one sidewall 6 is provided on its exterior surface a series of protuberances 8 alternating with voids 9, the tire 1 is able to withstand particularly violent lateral knocks without creating substantial damage that could possibly carry appreciable risk to the vehicle passengers. Since protuberance 8 consists of the base part 81, capability of such protuberance 8 to withstand particularly violent lateral knocks is maintained.

The top surface 82a of the top part 82 comprises one inclined face 83 axially inwardly inclined, and the flat face 82b axially inwardly inclined toward radially inward direction and connected by the connecting part 84 to the inclined face 83. The height hp of the protuberance 8 from the exterior surface of the sidewall 6 is maximal at the connecting part 84. The air to be evacuated between molding element and green tire would surely and smoothly be guided to the connecting part 84 where the green tire touches to the molding element at the very last moment during vulcanization, thus it is possible to efficiently evacuates air between the molding element and the green tire by providing venting holes at or around a portion for vulcanizing the connecting part 84 on the molding element. Therefore, it is possible to achieve evacuation with less number of venting holes, which leads favorable aesthetic of the protuberance 8 and the tire 1.

The tire 1, and a mounted rolling assembly comprising a rim 10 and the tire 1 according to the disclosure also have the advantage of offering overall performance, such as rolling resistance, wear, endurance, that is similar to that of tires without protuberances on the sidewall.

Since the difference between the height hp of each the protuberance 8 and the height hb of the base part 81 of the protuberance 8 is at most equal to 2.0 mm or at most equal to 50% of the height hp of the protuberance whichever is smaller, it is possible to achieve both the robustness of the sidewall 6 and of the carcass reinforcement 2 and good air evacuation efficiency from a space between the molding element and the green tire at the same time. In other words, if this difference is more than 2.0 mm or more than 50% of the height hp of the protuberance 8, there is a risk that the protuberance 8 bends too much during lateral knocks and may be destroyed. By setting this difference at most equal to 2.0 mm or at most equal to 50% of the height hp of the protuberance 8 whichever is smaller, robustness of the sidewall 6 and of the carcass reinforcement 2 is maintained while also maintaining good air evacuation efficiency from a space between the molding element and the green tire.

Since the height hp of each protuberance 8 is at least equal to 2.0 mm and at most equal to 10.0 mm, the protuberance 8 is able to provide enough robustness of the sidewall 6 and of the carcass reinforcement 2 without degrading overall performance of the tire.

If this height hp is less than 2.0 mm, robustness of the sidewall 6 and the carcass reinforcement 2 would be degraded due to insufficient volume of the protuberance 8. If this height hp is more than 10.0 mm, a size of the protuberance 8 becomes important and may penalize one of overall performance such as rolling resistance.

Since the width wp of each the protuberance 8 is at least equal to 2.5 mm and at most equal to 12.0 mm, the protuberance 8 is able to provide enough robustness of the sidewall 6 and of the carcass reinforcement 2 without degrading overall performance of the tire.

If this width wp is less than 2.5 mm, robustness of the sidewall 6 and of the carcass reinforcement 2 cannot be sufficiently improved due to insufficient volume of the protuberance 8 as the protuberance 8 may bend easily by lateral knock. If this width wp is more than 12.0 mm, a size of the protuberance 8 becomes important and may penalize one of overall performance such as rolling resistance.

Since two adjacent protuberances 8 are spaced apart by a distance less than or equal to twice the width wp of the protuberance 8, it is possible to prevent a risk that lateral knocks occurs on the sidewall 6 where no protuberance 8 exists (or at the void 9) with minimum amount of extra rubber due to protuberance 8, thus satisfactory robustness of the sidewall 6 and the carcass reinforcement 2 would be maintained without degrading overall performance of the tire.

Since each the protuberances 8 is oriented so as to extends in radial direction, it is possible to design the series of protuberance 8 in harmony with the tread pattern thus increases efficiency to design such the series of protuberance 8.

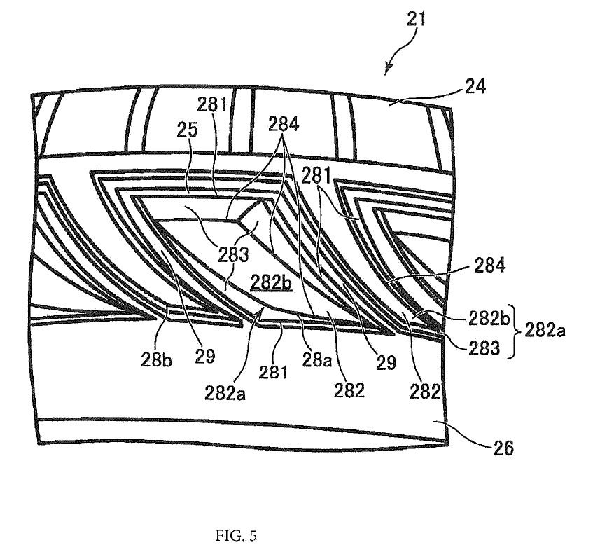

A tire 21 according to a second embodiment of the present disclosure will be described referring to FIG. 5. FIG. 5 is an enlarged schematic view of a portion of sidewall of the tire according to the second embodiment of the present disclosure. The constitution of this second embodiment is similar to that of the first embodiment except the arrangement shown in FIG. 5, thus description will be made referring to FIG. 5.

In the second embodiment, two different types of protuberances 28a and 28b are circumferentially alternately provided on an exterior surface of a sidewall 26 alternating with voids 29. The radially outward end of the first protuberance 28a is adjacent to a circumferential groove 25 connected to the void 29, and the radially outward end portion of the second protuberance 28b completely interrupts or extends through the circumferential groove 25 to reach a tread 24.

The protuberances 28a consist of a base part 281 integrally formed with the exterior surface of the sidewall 26, and a top part 282 extending outwardly from the base part 281 and having a top surface 282a spaced outwardly from the exterior surface of the sidewall 26. The top surface 282a includes a central flat face (remaining face) 282b. The central flat face 282b is connected to inclined faces 283 axially inwardly inclined through a connecting part 284.

The protuberances 28b consist of a base part 281 integrally formed with the exterior surface of the sidewall 26, and a top part 282 extending outwardly from the base part 281 and having a top surface 282a spaced outwardly from the exterior surface of the sidewall 26. The top surface 282a includes a central flat face (remaining face) 282b. The central flat face 282b is connected to inclined faces 283 axially inwardly inclined through a connecting part 284.

A height hp (not shown) of the protuberance 28a, 28b from the exterior surface of the sidewall 26 is maximal at each the connecting part 284.

Two protuberances 28a and 28b have different length lp (not shown) from one another and different width wp from one another. Two protuberances 28a and 28b may have different height hp (not shown) from one another, and may have different height hb (not shown) of the base part 281 from one another.

The height hp (not shown) of the protuberance 28a, 28b from the exterior surface of the sidewall 26 is maximal at the connecting part 284. Therefore, it is possible to further improve air evacuation efficiency from a space between the molding element and the green tire by providing venting holes at or around a portion for vulcanizing the connecting part 284 on the molding element. Therefore, it is possible to achieve evacuation with less number of venting holes which leads further favorable aesthetic of the protuberance 28a, 28b and the tire 21.

Since the top part 282 comprises a face spaced outwardly from the exterior surface of the sidewalls, it is possible to add freedom to design the protuberance 28a, 28b having further favorable aesthetic while maintaining good air evacuation efficiency between the molding element and the green tire 21.

Since at least two protuberances 28a, 28b have different length lp from one another and different width wp from one another, it is possible to add freedom to design the protuberance 28a, 28b as a series of protuberances 28 having further favorable aesthetic while maintaining good air evacuation efficiency between the molding element and the green tire. This effect would further be emphasized by setting at least two protuberances 28a, 28b to have different height hp from one another, and/or to have different height hb of the base part 281 from one another.

In order to confirm the effect of the present disclosure, computer simulation (finite element analysis) using commercially available computer software has been conducted. One type of tire model of Example to which the present disclosure is applied and another type of tire model of Comparative Example was prepared.

The protuberance of the Example is as presented in FIG. 3, and the width wp is 4.0 mm, the height hp is 4.5 mm, the length lp is 40.0 mm and the height hb is 4.0 mm. The protuberances are spaced apart in circumferential direction one another in the distance of 4.0 mm. The protuberance of the Comparative Example is similar to the Example without the inclined face thus without no connecting part, that is to say the width wp is 4.0 mm, the height hp is 4.5 mm, the length lp is 40.0 mm and the protuberances are spaced apart in circumferential direction one another in the distance of 4.0 mm, and the height hp of the protuberance which is equal to the height hb is constant in whole top part.

Force was applied to the top part of the protuberance, and an energetic elongation at 0.7 mm from bottom of the protuberance was simulated. The simulation result showed equivalent, or even lower energetic elongation which means better robustness performance of the Example over the Comparative Example.

The disclosure is not limited to the examples described and represented and various modifications can be made there without leaving its framework.

### REFERENCE SIGNS LIST

1, 21 tire
2 carcass reinforcement
3 crown reinforcement
4, 24 tread
5, 25 circumferential groove
6, 26 sidewall
7 bead zone
7a circumferential reinforcing element
8, 28 protuberance
81, 281 base part
82, 282 top part
82a, 282a top surface
82b, 282b flat face (remaining face)
83, 283 inclined face
84, 284 connecting part
9 void
10 rim

What is claimed is:

1. A tire for a rolling assembly comprising a rim and a tire, the tire comprising at least one carcass reinforcement, a crown reinforcement being disposed radially outward of the carcass reinforcement and being made up of at least one layer of reinforcing elements, a tread being placed radially outward of the crown reinforcement and having two axially outermost ends, at least one of the axially outermost end of the tread comprising a circumferential groove, the tread being connected by two sidewalls to two bead zones each comprising at least one circumferential reinforcing element, at least one sidewall comprising, on its exterior surface, a series of protuberances alternating with voids, each protuberance having a height hp, a length lp and a width wp being positioned at the surface of the sidewall, each the protuberance comprising a base part having a height hb and formed on the exterior surface of the sidewall and a top part extending outwardly from the base part and having a top surface spaced outwardly from the exterior surface of the sidewall wherein the top surface comprises at least one inclined face axially inwardly inclined and a remaining face connected to the inclined face by a connecting part, and wherein a height hp of the protuberance from the exterior surface of the sidewall is maximal at the connecting part.

2. The tire according to claim 1, wherein the top part comprises at least three faces.

3. The tire according to claim 1, wherein the top part comprises a top face independent from the base part.

4. The tire according to claim 1, wherein at least two protuberances have different length lp from one another.

5. The tire according to claim 1, wherein at least two protuberances have different width wp from one another.

6. The tire according to claim 1, wherein at least two protuberances have different height hp from one another.

7. The tire according to claim 1, wherein at least two protuberances have different height hb of the base part from one another.

8. The tire according to claim 1, wherein a difference between the height hp of each the protuberance and the height hb of the base part of the protuberance is at most equal to 2.0 mm or at most equal to 50% of the height hp of the protuberance whichever is smaller.

9. The tire according to claim 1, wherein the height hp of each the protuberance is at least equal to 2.0 mm and at most equal to 10.0 mm.

10. The tire according to claim 1, wherein the width wp of each the protuberance is at least equal to 2.5 mm and at most equal to 12.0 mm.

11. The tire according to claim 1, wherein two adjacent protuberances are spaced apart by a mean distance less than or equal to twice the width wp of the protuberance.

12. The tire according to claim 1, wherein two adjacent protuberances are substantially parallel from one another.

13. (canceled)
